(19) United States
(12) Patent Application Publication
(10) Pub. No.: US 2018/0339471 A1
(43) Pub. Date: Nov. 29, 2018

(54) SLITTING

(71) Applicant: Hexcel Composites Limited, Duxford (GB)

(72) Inventor: John Ellis, Duxford (GB)

(21) Appl. No.: 15/985,738

(22) Filed: May 22, 2018

(30) Foreign Application Priority Data
May 25, 2017 (GB) 1708404.7

(51) Int. Cl. B29C 70/54; B65H 35/02

(52) U.S. Cl. CPC B29C 70/545; B29C 70/386; B65H 35/02

(57) ABSTRACT

The present invention relates to an apparatus for slitting a web into a plurality of narrower segments comprising a feed for the web, a slitting system and one or more drivers for driving the web through the slitting system. The drivers contact the web on one side with its contact surface, and its contact surface has a surface roughness Ra in the range of from 20 to 0.2 micrometres, preferably from 20 to 3 micrometres.

### BACKGROUND OF THE INVENTION

### 1. Field of the Invention

The present invention relates to improvements in or relating to the slitting of webs into a plurality of segments comprising narrower sections and to improved equipment for slitting. In particular the invention relates to the slitting of prepregs into tapes and in particular to tapes which are used in the automatic lay up of prepreg tapes as is performed in the manufacture of articles such as sporting goods, aerospace components and wind energy components from the tapes of prepregs, typically using the automated tape laying (ATL) or automated fibre placement (AFP) techniques.

### 2. Description of Related Art

The term prepreg is a conventional term used in relation to fibrous reinforcement materials that are impregnated with an uncured or partially cured curable resin formulation which can be shaped and cured, usually by heat to produce fibre reinforced articles. The fibrous reinforcement material may be glass fibre, carbon fibre, aramid or other fibrous materials. In the present invention the fibrous material is usually unidirectional within the prepreg so that the unidirectional fiber tows are aligned in the direction in which the prepreg is moving when it is being slit.

The slitting of prepregs into tapes is a well-known technique and equipment is available for the slitting of continuously moving prepregs. Prepregs are usually provided with a backing paper sheet on at least one surface to enable the prepreg to be wound onto rolls to prevent adjacent layers within the roll from adhering to each other. However the presence of the paper backing sheet during slitting adversely impacts the accuracy of the slitting and can result in an undesirable variation in the width of the tapes produced by the slitting. Furthermore, the presence of the paper during slitting results in wasteful offcuts of the paper, and contamination of the prepreg with paper waste. It has therefore been proposed to remove the backing paper prior to slitting and to provide a liner to the tape after slitting just prior to wind up to enable the tapes produced in the slitting process to be wound into a roll without adjacent layers of the tapes in the roll from adhering to each other. (See US2013/0284847.)

In our PCT publication WO2012/020109, it is suggested that a flexible polymeric backing material rather than paper may be applied to the prepreg before slitting which remains attached to the prepreg during slitting and that this results in a tighter tolerance in the width of the tape produced by slitting. The use of the flexible polymeric material as a backing for the original prepreg is however costly but allows winding of the product on a spool without the need to add a slightly wider polymeric material as interleave as the prepreg slit tape is wound, thus reducing cost. The polymeric backing prevents the layers of prepreg material from sticking to themselves on the spool and facilitate unwinding of the prepreg for its end use application.

For applications of slit tape in the manufacture of composite articles using robotically controlled ATL and AFP, it is very important that the width of the tapes is accurately controlled and that any variation in width along the length of the tape is minimised, because variations as small as fractions of a millimetre can make the tape unsuited to making uniform lay-ups.

The tapes after slitting can be of a considerable length for example they may have a length of at least 500 metres, typically at least 1000 metres and in some instance at least 4000 metres.

The tapes are usually of substantially rectangular cross-section and the cross-section should be well-defined with a clear constant width and a clear constant thickness. The preferred width of the tapes will depend upon the use to which the tape is to be put however it is typically in the range of from 2.0 to 50 mm, preferably from 3.0 to 25 mm and most preferably 3.175 mm, 6.35 mm, 12.7 mm or 25.4 mm. For automated lay-up machines the widths can be 25.4 mm 38.1 mm 50 nm and up to 75 mm wide. However depending on the applications the width may also range from 10 mm to 3500 mm, or from 50 mm to 3000 mm, or from 100 mm to 2000 mm, or from 150 mm to 2000 mm, or from 200 mm to 2000 mm. The thickness is typically in the range of from 0.05 to 1.0 mm, primarily depending on the quantity of fibres per strip as desired according to the application.

Although current slitting machines are able to produce tapes of the required dimensions and with acceptable tolerances in width variation, they are only able to do so by slitting prepregs travelling relatively slowly such as at a speed of less than 20 metres per minute. There is therefore a need to provide improvements to slitting machines and slitting technology which enable consistent slitting of continuously moving prepregs to provide tapes of constant width and thickness from prepregs that are moving at speeds greater than 20 typically greater than 25 metres per minute.

### SUMMARY OF THE INVENTION

The invention further aims to mitigate and/or obviate the above described problems and/or to provide improvements generally.

According to the invention there is provided an apparatus, a process and a use as defined in any one of the accompanying claims.

### BRIEF DESCRIPTION OF THE DRAWINGS

FIG. 1 is a schematic illustration of the passage of a web for slitting according to the invention.

FIG. 2 shows the rollers employed for the take-off of the individual tapes.

### DETAILED DESCRIPTION OF THE INVENTION

In an embodiment of the invention, the backing material is removed from the moving prepreg/backing material system prior to slitting by continuously passing the moving prepreg/backing material system over a roller where the prepreg is separated from the backing material and the prepreg is then passed to a slitting system where the slitting is performed. The backing material is preferably a paper backing material.

The slitting system typically comprises a substrate such as a roller provided with grooves into which mating blades fit so as to slit the prepreg into tapes of width corresponding to the distance between the blades. However, as the speed of the prepreg/backing material system is increased, the removal of the backing material prior to slitting is more difficult to control. In addition, the prepreg without its backing material can stick to the substrate and to the take-off rollers. Each of these aspects can cause undesirable variability in the width and thickness of the tape.

We have found that these problems may be overcome by employing a driver that drives the materials through the slitting machine by providing that the surface of the driver has a certain surface roughness. The driver may be positioned at any suitable position in the path of the web. For example, it may be positioned so that its roughened contact surface contacts the web prior to slitting. Alternatively its contact surface may contact the tapes after slitting has been performed. The driver may comprise one or more rollers or it may be a conveyor; it is however driven at the speed of movement required of the web or the tapes produced therefrom. In a preferred embodiment the driver comprises tube of roller or rollers for the layers.

The surface roughness of the driver is selected depending upon the speed of operation required of the entire slitting activity and the materials employed. It is selected to maintain a constant tension on the tapes whilst not reducing the width of the tapes. Surface roughness is defined as the “average surface roughness Ra” which is the average deviation from the mean surface level and is defined by the formula

$${R}_{a} = \frac{1}{n} {\sum }_{i = 1}^{n} \vert {y}_{i} \vert$$

Wherein n is a number of measurements taking of the surface elevations or depressions along the surface in relation to a median and y represents a surface measurement of surface elevations or depressions (in micrometres). Typically n is at least 25 or greater and for the purpose of this application n is 50 measurements over the length of the measured surface

We have found that a surface roughness Ra in the range of from 20 to 3 micrometres, preferably 15 to 4, more preferably 10 to 7 micrometres, is particular suitable. Alternative surface roughness Ra may be in the range of from 0.2 μm to 5 μm, or from 0.3 μm to 4 μm, or from 0.3 μm to 2 μm or from 0.4 μm to 1.5 μm and/or combinations of the aforesaid ranges.

Accordingly in one embodiment of this invention the web comprises a prepreg provided with a first backing material and the first backing material is removed shortly ahead of the slitting system and in a preferred embodiment a second backing material is applied to the prepreg shortly ahead of the slitting system. The new backing material is provided on the surface of the tapes that will be adjacent to the drive rollers so that the speed of the movement of the tapes and accordingly the original speed of movement of the prepreg provided with the backing paper will be determined by the speed at which the drive rollers are driven and the retention provided between the roughened surface of the drive rollers and the new backing material.

The purpose of the backing material is at least twofold; firstly it is to provide a layer between layers of prepreg when the web and the tapes derived therefrom are wound into way-wound spools or into reels. Secondly the backing material provides the surface of either the web or the tapes that contacts the roughened surface of the driver to prevent the resin of the prepreg contacting the contact surface of the driver. A third use of the backing material particularly if it is a flexible polymeric material is that it helps to maintain the dimensions of the slit tapes within the required tolerances.

Accordingly when the first backing material is in the form of paper which is removed prior to slitting and the driver is employed prior to slitting, the paper contacts the roughened surface of the driver which is then removed at a position between the driver and the slitting unit. If however the driver is positioned after slitting and the fist backing material is paper the first paper backing material will be removed prior to slitting and a second backing material will be applied either shortly before the slitting system or applied shortly following the slitting ahead of the driver positioned after the slitting system so that it is the second backing material that contacts the roughed surface of the driver. If however the first backing material on the original web is a flexible polymeric film it may be possible to leave the first backing material in contact with the prepreg throughout the slitting and tape winding operations.

A second backing material may be applied to the tapes after slitting. This may be paper based material although more preferably it is a strip of flexible polymeric material such as a polyolefin film for example a polyethylene or a polypropylene film. We prefer that the original backing on the prepreg to be slit is a polymeric backing which is left on the prepreg throughout the slitting and winding operation. Alternatively, if the backing material is provided to the tapes after slitting of the prepreg and before the slit tapes reach the driver the back material is positioned after slitting.

The backing material may be provided from rollers and the speed of take-off and feed to the tapes may be controlled by the speed of the driver. The backing material is preferably of a width which is greater than the width of the tapes, thus eliminating the need for a further polymeric backing material to be applied as the product is made into spools or reels. The backing material should be such that it can be readily removed from the tapes when they are used in article manufacture such as in automatic tape lay-up processes.

When the first backing material is removed from the original prepreg prior to slitting it is preferably removed as the prepreg/backing paper system passes around a roller with the prepreg moving on to the slitting system and the first backing paper being removed typically upon contact with a roller of typically 120 mm diameter. The first backing paper is preferably removed by means of driven winding unit with tension control in which paper removal is synchronised with the speed of the driver system (with the roughened surface) to ensure that the backing paper is removed at the desired speed of operation and does not damage or distort the prepreg due to speed differences.

In a further embodiment the substrate where slitting takes place is a roller which is cylindrical. The roller is provided with a series of grooves into which mating slitting knives fit. As a further embodiment the cutting point of the slitting blades are shaped with one straight edge and one bevelled edge. The blades are made of hard metal such as hardened stainless steel. In a further embodiment the temperature of the roller provided with the grooves upon which the slitting takes place is controlled to control the viscosity of the resin in the prepreg during slitting to avoid contamination of the slitting blades with resin and to increase or reduce tack. Typically the temperature is controlled to be in the range 10 to 60° C. and preferably between 15 and 20° C. for cool conditions or between 40 and 60° C. for warm conditions depending on the resin system viscosity profile. A viscosity range of 20,000 Pa·s to 10,000 Pa·s is preferred for cool conditions and a range of from 10,000 Pa·s to 200 Pa·s is preferred for warm slitting conditions.

The slitting unit employed in the present invention typically comprises one or more rotary blades positioned so that the sheet of prepreg is pressed into contact with the blade or blades. The slitting unit preferably comprises a roller provided with grooves into which the blades fit so that the prepreg is cut into tapes of the width of the distance between the blades. Generally it is desirable to produce strips of prepreg of the same width from a single sheet of prepreg, thus preferably any blades are evenly spaced apart and it is preferred that the spacing of the blades can be adjusted to enable tapes of different widths to be produced.

The invention is particularly concerned with slitting prepregs. The fibres in the prepregs are preferably unidirectional fibres and they may comprise cracked (i.e. stretch-broken), selectively discontinuous or continuous fibres, although continuous fibres are preferred. The term “unidirectional” is a term of art and means that the fibres are aligned with a common direction and each fibre is free and not interwoven with the other fibres across the width of the prepreg. Preferably the direction is axially along the direction in which the prepreg moves.

The unidirectional fibres may be made from a wide variety of materials such as carbon, graphite, glass, metallised polymers aramid and mixtures thereof.

The fibres are preferably substantially completely impregnated with uncured or partially cured resin, with all of the fibres being in contact with the curable resin.

The curable thermosetting resin may be selected from epoxy resins, isocyanate resins, polyester resins and phenolic resins in combination with one or more curatives. Preferably the curable resin is an epoxy resin.

Suitable epoxy resins may comprise monofunctional, difunctional, trifunctional and/or tetrafunctional epoxy resins.

Suitable difunctional epoxy resins, by way of example, include those based on, diglycidyl ether of Bisphenol F, Bisphenol A (optionally brominated), phenol and cresol epoxy novolacs, glycidyl ethers of phenol-aldelyde adducts, glycidyl ethers of aliphatic diols, diglycidyl ether, diethylene glycol diglycidyl ether, aromatic epoxy resins, aliphatic polyglycidyl ethers, epoxidised olefins, brominated resins, aromatic glycidyl amines, heterocyclic glycidyl imidines and amides, glycidyl ethers, fluorinated epoxy resins, or any combination thereof.

Difunctional epoxy resins may be preferably selected from diglycidyl ether of Bisphenol F, diglycidyl ether of Bisphenol A, diglycidyl dihydroxy naphthalene, or any combination thereof.

Suitable trifunctional epoxy resins, by way of example, may include those based upon phenol and cresol epoxy novolacs, glycidyl ethers of phenol-aldehyde adducts, aromatic epoxy resins, aliphatic triglycidyl ethers, dialiphatic triglycidyl ethers, aliphatic polyglycidyl ethers, epoxidised olefins, brominated resins, triglycidyl aminophenyls, aromatic glycidyl amines, heterocyclic glycidyl imidines and amides, glycidyl ethers, fluorinated epoxy resins, or any combination thereof.

Suitable tetrafunctional epoxy resins include N,N, N′,N′-tetraglycidyl-m-xylenediamine (available commercially from Mitsubishi Gas Chemical Company under the name Tetrad-X, and as Erisys GA-240 from CVC Chemicals), and N,N,N′,N′-tetraglycidylmethylenedianiline (e.g. MY721 from Huntsman Advanced Materials).

In view of the length of the tapes produced according to this invention, the tape is typically wound, way-wound, onto a core material as a spool. A particularly suitable winding involves the tape passing up and down the core as it is wound, like a thread on a spool with multiple windings in one direction being possible before the tape winds back the other way on top of previous windings of strip. Such a method of winding is called “way-wound”.

Before slitting, the sheet of prepreg can be manufactured in a conventional prepreg manufacturing process. As discussed above, it is conventional for a backing paper to be applied during prepreg manufacture. If this is the case then the paper must be removed before the prepreg passes to the slitting stage.

Alternatively, although less preferred, the sheet of prepreg can be manufactured with a polymeric sheet as the backing material instead of using paper. As the resin impregnation stage of prepreg manufacture can involve high temperatures, the polymeric sheet must be heat-tolerant in this embodiment.

However the sheet of prepreg is manufactured, it is generally the case that the polymeric sheet will have been pressed onto the resin and fibres under high pressure. This serves to form a stronger adhesive bond between the polymeric sheet and the resin and fibres and is believed to contribute to how the polymeric sheet acts to maintain the uniform width of the strip through and beyond the slitting operation.

Thus, when used it is preferred that the polymeric sheet has been applied under a compressive force before reaching the slitting stage, of at least 0.1 MPa, more preferably at least 0.2 MPa, most preferably at least 0.4 MPa.

Accordingly in a preferred embodiment of the invention a prepreg provided with a first backing material such as a backing paper is provided typically from a feed roller which may be part of the slitting machine. If required the prepreg/first backing material layer is fed to a trimming unit which trims the layer to a smaller width in preparation for slitting. The trimmed layer or original prepreg/first backing material then passes to a driven roller with the first backing sheet in contact with the surface of the roll and the prepreg is separated from the first backing material as it passes over the roller. The temperature of the surface of this roller may be controlled according to the speed at which the prepreg/backing material is moving and also according to the nature of the resin to prevent any premature curing of the resin.

The first backing material is removed from the prepreg under tension and the prepreg then passes to lamination roll where a new backing material is applied and typically this is a polymeric backing material. Polymeric backing materials may comprise a polyolefin based backing material.

The prepreg with the polymeric backing material passes to a slitting unit where it is slit into tapes which are withdrawn from the slitting unit by a driver which preferably comprises a driven roller. The driver roller can be provided with grooves for each tape and the temperature of the surface of this roller is controlled to prevent premature curing of the resin in the tape and also to prevent the tape sticking to the surface of the roller. The individual tapes then pass to take off rollers driven at the speed required for efficient and effective slitting. These rollers having a roughened surface to allow the tapes to be held on their surface and also to pass smoothly over their surface without sticking thereto. The optimum degree of roughness will depend upon the speed set for the movement of the tapes and the composition of the tapes in terms of the nature of the resin and the nature of the fibres in the tapes as well as the relative proportions of the two. The tapes may then pass to wind up spools or bobbins. The second backing material is provided to the tapes ahead of the slitting system and contacts the driver to prevent the slit tapes from sticking to the driver and also to themselves during subsequent wind up.

We have found that when employing the equipment and the method of the invention the prepregs can be slit accurately into tapes of constant width and thickness while travelling at speeds of above 25 metres/minute and up to 100 metres per minute typically in the range of 30 to 60 metres per minute.

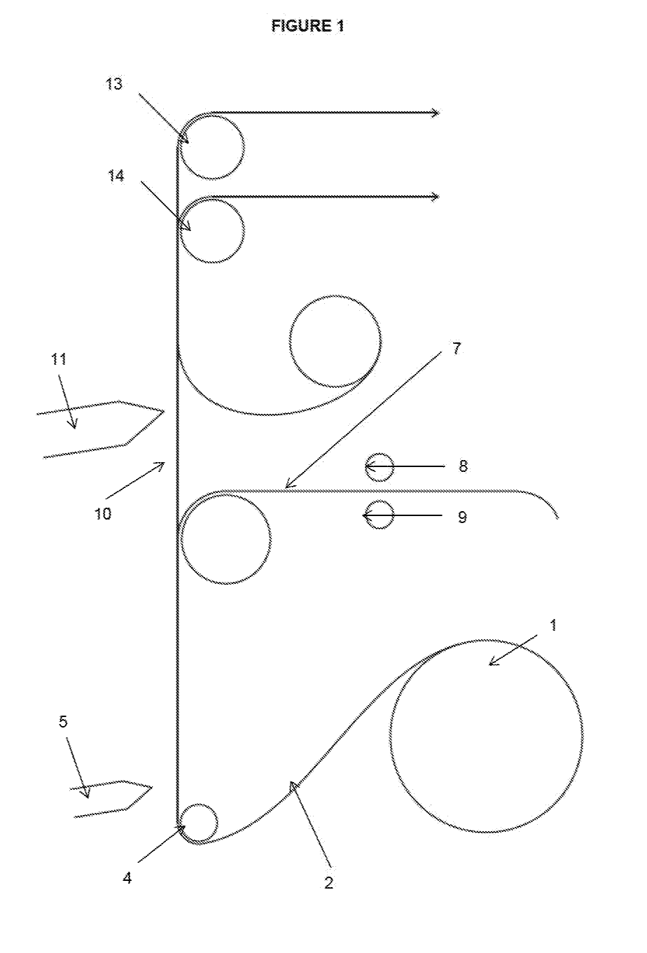

The invention is illustrated by the accompanying figures in which FIG. 1 shows a driven feed roll (1) from which prepreg (2) provided with a backing material (3) is withdrawn, the material being on the upper side of the prepreg. The system passes around a tensioning roller (4) to a trimming unit (5) which automatically trims the system to the width required for slitting. The trimmed web then passes to a driven roll (6) whose surface temperature is controlled where the backing material (7) is separated from the prepreg and is taken off by driven rolls (8) and (9) which provide the desired tension for removal of the material from the prepreg. The off cuts resulting from the trimming of the system are also taken away from the prepreg at this roller and are fed to collection for reuse.

The prepreg (10) (now separated from the backing material) then passes to the slitting unit (11) comprising a roller with grooves (not shown) into which a plurality of blades (not shown) fit to slit the web into tapes of the required predetermined width. The individual tapes are then taken off by driven rollers (13) (14) whose surface temperature is controlled with a roughened surface to prevent the tapes slipping on the surface thereof and also to prevent the tapes from sticking thereto pass through the machine. The tapes then pass to windup bobbins (not shown).

A polymeric second backing material (15) is applied to the individual tapes after slitting and before they reach the rollers (13), (14) having the roughened surface.

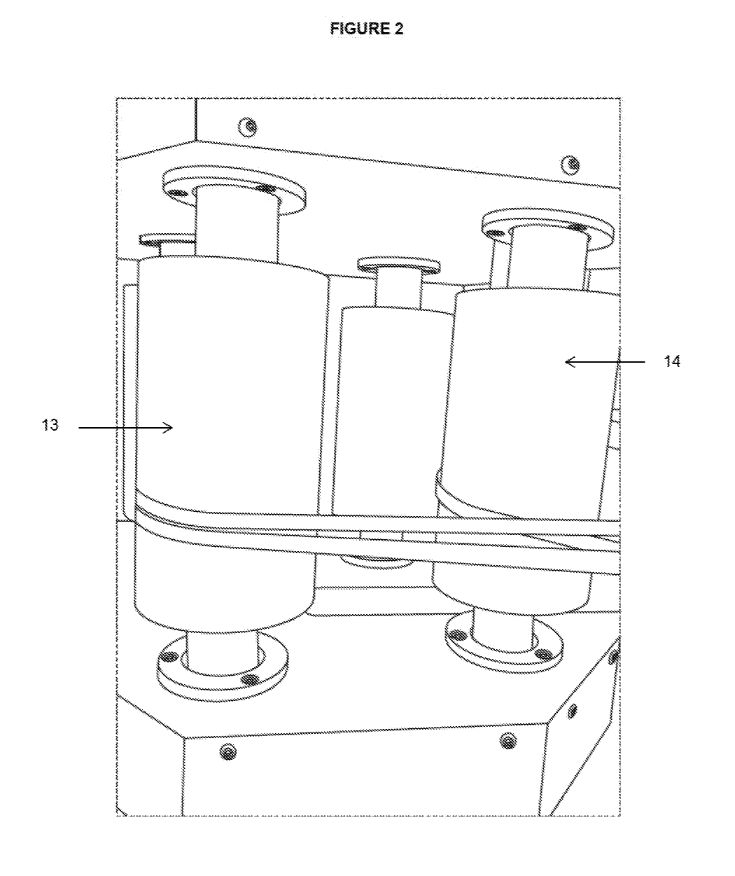

FIG. 2 shows the take-off rollers (13) and (14) which drive the system through the machine and which are provided with a roughened surface (25) and (26) to prevent the moving tapes (16) and (17) from sticking to the surface of the rollers.

1. An apparatus for slitting a web into a plurality of narrower segments comprising a feed for the web, a slitting system and one or more drivers for driving the web through the slitting system, wherein the driver contacts the web on one side with its contact surface, the contact surface having a surface roughness Ra in the range of from 20 to 0.2 micrometres.

2. An apparatus according to claim 1, wherein the driver contacts the narrower segments.

3. An apparatus for slitting according to claim 1, wherein the web comprises a prepreg provided with a first backing material and the machine includes means for removal of the first backing material from the web before it enters the slitting system.

4. An apparatus for slitting according to claim 3 including means for provision of a second backing material to the narrower segments after slitting.

5. An apparatus according to claim 4 in which the driver is positioned beyond the slitting system and the second backing is provided at a position before the narrower segments reach the driver.

6. An apparatus for slitting according to claim 5 in which the contact surface contacts the second backing material.

7. An apparatus according to claim 1 in which the web moves at a speed of greater than 20 meters/minute.

8. An apparatus according to claim 1 in which the slitting system comprises a pair of corresponding rollers one roller provided with multiple slitting blades and the opposite roller being provided with grooves corresponding to the location of the blades.

9. A machine according to claim 8 in which the temperature of the roller provided with grooves is controlled to a temperature in the range of from 10 to 60° C.

10. An apparatus according to claim 8, wherein the slitting blades are parallel to one another.

11. An apparatus according to claim 8, wherein the slitting blade are movable relative to one another.

12. A process for slitting a moving web into a plurality of narrower segments comprising feeding the web to a slitting system and withdrawing the narrower segments from the slitting system wherein the web is driven by contact between the web and a driver wherein the driver has a surface roughness Ra in the range of from 20 to 3 micrometers.

13. A process according to claim 12 in which the moving web comprises a prepreg provided with a first backing material and the first backing material contacts the contact surface of the driver.

14. A process according to claim 13 in which the fist backing material is removed prior to the web entering the slitting system.

15. A process according to claim 12 in which the driver is positioned beyond the slitting system.

16. A process according to claim 12 in which a second backing material is provided to the narrower segments at a position between the slitting system and the take-off rollers.

17. A process according to claim 16 in which the second backing material is provided on the side of the narrower segments that will be adjacent to the roughened surface of the take-off rollers.

18. A process according to any of claim 12 in which the web moves at a speed greater than 20 meters/minute.

19. A process according to claim 12 for the production of prepreg tapes to be used in automatic tape lay-up fabrication techniques.

20. An automatic tape lay-up fabrication employing a tape produced by a process according to claim 12.
